(19) United States
(12) Patent Application Publication
(10) Pub. No.: US 2018/0199035 A1
(43) Pub. Date: Jul. 12, 2018

(54) METHOD AND APPARATUS FOR FAST INTRA PREDICTION

(71) Applicant: MEDIATEK INC., Hsin-Chu (TW)

(72) Inventors: Tung-Hsing Wu, Hsin-Chu (TW); Kun-Bin Lee, Taipei City (TW); Yi-Hsin Huang, Hsin-Chu (TW)

(21) Appl. No.: 15/913,933

(22) Filed: Mar. 7, 2018

Related U.S. Application Data
(62) Division of application No. 14/492,082, filed on Sep. 22, 2014.
(60) Provisional application No. 61/889,574, filed on Oct. 11, 2013.

(51) Int. Cl. H04N 19/119; H04N 19/11; H04N 19/176; H04N 19/122; H04N 19/154

(52) U.S. Cl. CPC H04N 19/119; H04N 19/11; H04N 19/154; H04N 19/122; H04N 19/176

(57) ABSTRACT

An intra prediction method includes: based on a specific transform unit size, estimating a plurality of best intra prediction modes of a plurality of second blocks, wherein a first block is composed of the second blocks, the first block supports a first block configuration and a second block configuration, the first block configuration represents a size of the first block, and the second block configuration represents a size of each second block; and checking similarity of the best intra prediction modes of the second blocks for selectively replacing the second block configuration by the first block configuration for the first block.

### CROSS REFERENCE TO RELATED APPLICATION

This is a divisional application of U.S. application Ser. No. 14/492,082 filed Sep. 22, 2014, which claims the benefit of U.S. provisional application No. 61/889,574 filed Oct. 11, 2013. The entire contents of the related applications, including U.S. application Ser. No. 14/492,082 and U.S. provisional application No. 61/889,574, are incorporated herein by reference.

### BACKGROUND

The disclosed embodiments of the present invention relate to video coding, and more particularly, to a method and apparatus for fast intra prediction.

The conventional video coding standards generally adopt a block based (or coding unit based) coding technique to exploit spatial redundancy. For example, the basic approach is to divide the whole source frame into a plurality of blocks (coding units), perform intra/inter prediction on each block (coding unit), transform residues of each block (coding unit) using discrete cosine transform, and perform quantization and entropy encoding. Besides, a reconstructed frame is generated in a coding loop to provide reference pixel data used for coding following blocks (coding units). For certain video coding standards, in-loop filter(s) may be used for enhancing the image quality of the reconstructed frame. For example, a de-blocking filter is included in an H.264 coding loop, and a de-blocking filter and a sample adaptive offset (SAO) filter are included in an HEVC (High Efficiency Video Coding) coding loop.

Intra prediction is employed to remove the spatial redundancies within one image. In a traditional video coding design, the estimation operations of intra prediction modes for different coding unit sizes are performed separately. For example, a distortion estimation of a 32×32 coding unit with a 16×16 transform unit size and a distortion estimation of a 16×16 coding unit with a 16×16 transform unit size are performed separately. Since the 16×16 coding unit is part of the 32×32 coding unit, the same distortion estimation for the 16×16 coding unit with the 16×16 transform unit size is performed again, thus resulting in a longer intra prediction processing time.

### SUMMARY

In accordance with exemplary embodiments of the present invention, a method and apparatus for fast intra prediction are proposed.

According to a first aspect of the present invention, another exemplary intra prediction method is disclosed. The exemplary intra prediction method includes: based on a specific transform unit size, estimating a plurality of best intra prediction modes of a plurality of second blocks, wherein a first block is composed of the second blocks, the first block supports a first block configuration and a second block configuration, the first block configuration represents a size of the first block, and the second block configuration represents a size of each second block; and checking similarity of the best intra prediction modes of the second blocks for selectively replacing the second block configuration by the first block configuration for the first block.

According to a second aspect of the present invention, another exemplary intra prediction apparatus is disclosed. The exemplary intra prediction apparatus includes an estimating circuit and a merging circuit. The estimating circuit is configured to refer to a specific transform unit size to estimate a plurality of best intra prediction modes of a plurality of second blocks, wherein a first block is composed of the second blocks, the first block supports a first block configuration and a second block configuration, the first block configuration represents a size of the first block, and the second block configuration represents a size of each second block. The merging circuit is configured to check similarity of the best intra prediction modes of the second blocks for selectively replacing the second block configuration by the first block configuration for the first block.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a portion of an image to be encoded by a video encoder using a proposed intra prediction apparatus of the present invention.

FIG. 2 is a diagram illustrating an intra prediction apparatus according to a first embodiment of the present invention.

FIG. 3 is a diagram illustrating an intra prediction method using a first distortion estimation flow according to an embodiment of the present invention.

FIG. 4 is a diagram illustrating an example of performing one distortion estimation to set distortion values for different coding unit sizes.

FIG. 5 is a diagram illustrating an intra prediction method using a second distortion estimation flow according to an embodiment of the present invention.

FIG. 6 is a diagram illustrating another example of performing one distortion estimation to set distortion values for different coding unit sizes.

FIG. 7 is a diagram illustrating an intra prediction apparatus according to a second embodiment of the present invention.

FIG. 8 is a diagram illustrating an example of updating a current best coding unit size by a coding unit size of a larger block when best intra prediction modes of smaller blocks within the larger block are identical.

FIG. 9 is a diagram illustrating one example of adjusting a transform unit size to find a final transform unit size under a condition that a coding unit size and an intra prediction mode are fixed.

FIG. 10 is a diagram illustrating another example of adjusting a transform unit size to find a final transform unit size under a condition that a coding unit size and an intra prediction mode are fixed.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

One concept of the present invention is to provide a modified intra prediction process, such that a distortion value of one block (e.g., a coding unit (CU) or a prediction unit (PU)) under an intra prediction mode is stored for different block sizes (e.g., different CU sizes or different PU sizes). Since the distortion value generated by a single distortion estimation can be used to set multiple distortion values for different block sizes, the repeated execution of the same distortion estimation can be avoided, thus reducing the intra prediction processing time. Another concept of the present invention is to update a current best coding unit size by a larger block size (e.g., a larger CU size or a larger PU size) when best intra prediction modes of smaller blocks (e.g., smaller CUs or smaller PUs)) in the larger block (e.g., a larger CU or a larger PU) are similar or identical. Since the current best coding unit size is updated by the coding unit size of the larger block without performing distortion estimations of different intra prediction modes to find a best intra prediction mode for the larger block, the intra prediction processing time can be reduced. Further details of technical features of the present invention are described as below.

The proposed intra prediction processes of the present invention are block-based processes. In one exemplary implementation, blocks processed by the proposed intra prediction process may be coding units, and block sizes of the blocks may be coding unit sizes. In another exemplary implementation, blocks processed by the proposed intra prediction process may be prediction units, and block sizes of the blocks may be prediction unit sizes. To put it simply, the same invention concept applied to coding units can also be applied to prediction units. For clarity and simplicity, technical features of the present invention are detailed hereinafter with reference to CU-based intra prediction processes. However, since the same invention concept applied to coding units can also be applied to prediction units, a person skilled in the pertinent art should readily appreciate that the terms “coding unit” and “prediction unit” are interchangeable, and the associated terms “coding unit size” and “prediction unit size” are also interchangeable. Further description directed to PU-based intra prediction processes that follow the same invention concept is omitted for brevity.

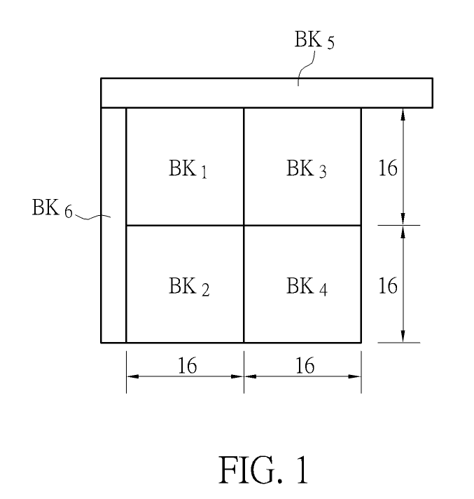

FIG. 1 is a diagram illustrating a portion of an image to be encoded by a video encoder using a proposed intra prediction apparatus of the present invention. In this example, one 32×32 coding unit is composed of 4 blocks BK₁, BK₂, BK₃, BK₄, each being one 16×16 coding unit. The block BK₅ is composed of upper reconstructed pixels of the 32×32 coding unit, and the block BK₆ is composed of left reconstructed pixels of the 32×32 coding unit. As known to those skilled in the pertinent art, the actual intra prediction process operates separately for each transform unit (TU), where the transform unit is the unit for transform and quantization. Suppose that the transform unit size of the 32×32 coding unit is 16×16, and the transform unit size of each 16×16 coding unit is also 16×16. Regarding the 32×32 coding unit size, the neighboring pixels which are used to generate the intra predicted pixels of the block BK₃ under part of intra prediction modes are from the reconstructed pixels of block BK₁ and part of block BK₅. Regarding the 16×16 coding unit size, the neighboring pixels which are used to generate the intra predicted pixels of the block BK₃ under part of intra prediction mode are also from the reconstructed pixels of block BK₁ and part of block BK₅. Hence, under the same transform unit size (e.g., 16×16), the neighboring pixels which are used to generate intra predicted pixels of each 16×16 block are the same in either of 32×32 coding unit size and 16×16 coding unit size. Thus, in the video coding, the intra prediction distortion for different coding unit sizes with the same transform unit size is similar. Based on such an observation, the present invention therefore proposes a modified intra prediction process to avoid repeated execution of the same distortion estimation.

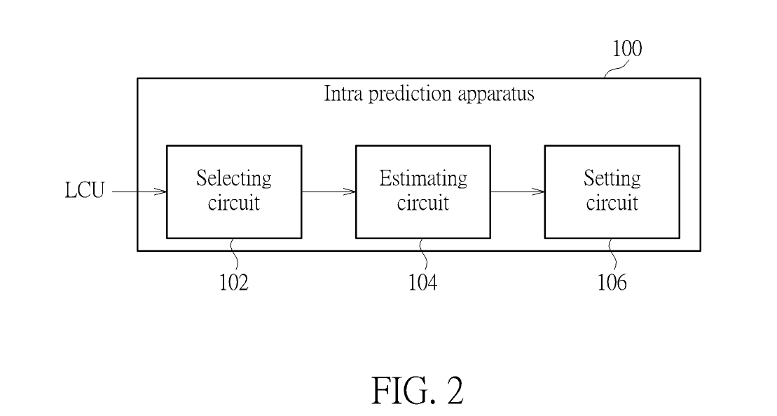

FIG. 2 is a diagram illustrating an intra prediction apparatus according to a first embodiment of the present invention. The intra prediction apparatus 100 may be part of a video encoder supporting one or more video coding standards (e.g., an HEVC standard). In this embodiment, the intra prediction apparatus 100 includes a selecting circuit 102, an estimating circuit 104, and a setting circuit 106. It should be noted that only the circuit components pertinent to the present invention are shown in FIG. 2. In practice, the intra prediction apparatus 100 may include additional circuit components for providing a complete intra prediction function. When a largest coding unit (LCU) in an image to be encoded is received by the intra prediction apparatus 100, the selecting circuit 102 is configured to make a selection of a transform unit size and an intra prediction mode (or a selection of a coding unit size, an intra prediction mode and a transform unit size), and update the current selection of the transform unit size and the intra prediction mode (or the current selection of the coding unit size, the intra prediction mode and the transform unit size). Specifically, the selecting circuit 102 does not stop updating the current selection of the transform unit size and the intra prediction mode (or the current selection of the coding unit size, the intra prediction mode and the transform unit size) until the distortion estimation flow is completed. The estimating circuit 104 is coupled to the selecting circuit 102, and configured to perform a distortion estimation to evaluate a distortion value of a specific block under a transform unit size and an intra prediction mode. The setting circuit 106 is coupled to the estimating circuit 104, and configured to use the same evaluated distortion value to set a distortion value of the same specific block under different block configurations, such as different coding unit size configurations or different prediction unit size configurations.

For example, the estimating circuit 104 evaluates the distortion of the specific block under an intra prediction mode, a transform size, and the first coding unit size. The setting circuit 106 uses the evaluated distortion value to set a distortion value of the specific block under the same intra prediction mode, the same transform size unit, and the second coding unit size. The first coding unit size is different from the second coding unit size. The transform unit size for evaluating the distortion of the specific block is not larger than the first coding unit size and the second coding unit size. In this way, the distortion value generated by a single distortion estimation performed by the estimating circuit 104 is used for directly setting distortion values of different coding unit sizes. The number of distortion estimations needed to be performed by the estimating circuit 104 is reduced, thus shorting the intra prediction processing time of each LCU. During the intra prediction process of one LCU, the distortion estimation of evaluating a distortion value of a block under one selected intra prediction mode and one selected transform unit size is performed for at least one coding unit size (e.g., different coding unit sizes) not smaller than the currently selected transform unit size. In one preferred embodiment, consider a case where a first combination of one selected intra prediction mode and one selected transform unit size and a second combination of one selected intra prediction mode and one selected transform unit size have different intra prediction modes and/or different transform unit sizes. For example, under the first combination of one selected intra prediction mode and one selected transform unit size, one distortion estimation may be performed only once to determine distortion values for different coding unit sizes. For another example, under the second combination of one selected intra prediction mode and one selected transform unit size, one distortion estimation may be performed only once to determine distortion values for different coding unit sizes. It should be noted that performing the distortion evaluation only once for each possible combination of intra prediction mode and transform unit size selected during the intra prediction process of one LCU is merely one feasible implementation of the present invention. In an alternative design, the intra prediction process of one LCU may be performed based partially on the traditional estimation method and partially on the proposed estimation method. For example, one distortion evaluation under the first combination of one selected intra prediction mode and one selected transform unit size may be repeatedly performed for obtaining distortion values for different coding unit sizes, and another distortion evaluation under the second combination of one selected intra prediction mode and one selected transform unit size may be performed only once for obtaining distortion values for different coding unit sizes. This also falls within the scope of the present invention.

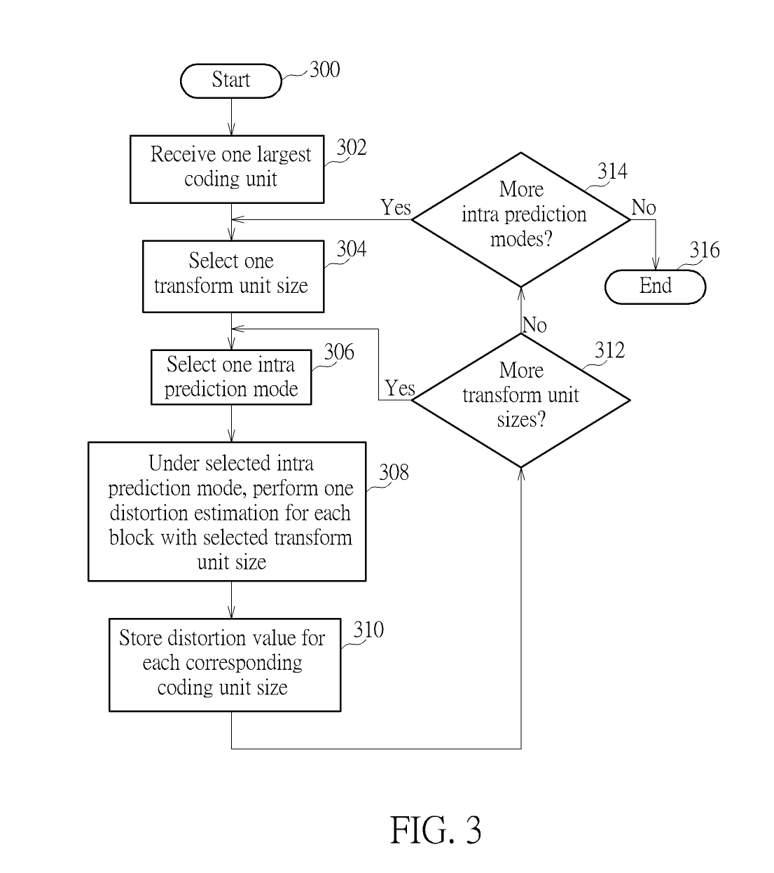

Based on different designs of the selecting circuit 102, the intra prediction apparatus 100 may be configured to employ different distortion estimation flows to achieve the same objective of avoiding repeated execution of the same distortion estimation. FIG. 3 is a diagram illustrating an intra prediction method using a first distortion estimation flow according to an embodiment of the present invention. Provided that the result is substantially the same, the steps are not required to be executed in the exact order shown in FIG. 3. The intra prediction method may be employed by the intra prediction apparatus 100, and can be briefly summarized as below.

Step 300: Start.

Step 302: Receive one largest coding unit (LCU).

Step 304: Select one transform unit size from unprocessed transform unit size(s).

Step 306: Select one intra prediction mode from unprocessed intra prediction mode (s) associated with the selected transform unit size.

Step 308: Under the selected intra prediction mode, perform one distortion estimation for each block with the selected transform unit size.

Step 310: Store a distortion value for each corresponding coding unit size.

Step 312: Check if there is any unprocessed intra prediction mode associated with the selected transform unit size. If yes, go to step 306; otherwise, go to step 314.

Step 314: Check if there is any unprocessed transform unit size. If yes, go to step 304; otherwise, go to step 316.

Step 316: End.

Steps 302, 304, 306, 312 and 314 may be performed by the selecting circuit 102. As can be seen from FIG. 3, the selecting circuit 102 sequentially selects possible combinations of the transform unit size and the intra prediction mode without considering the coding unit size (steps 304, 306, 312 and 314). For example, the selecting circuit 102 may make a selection of a first transform unit size and a first intra prediction mode, and then make another selection of the same first transform unit size and a second intra prediction mode. For another example, the selecting circuit 102 may make a selection of a first transform unit size and a first intra prediction mode, and then make another selection of a second transform unit size and a second intra prediction mode. Alternatively, the order of steps 304 and 306 may be swapped, and the order of steps 312 and 314 may be swapped.

Step 308 may be performed by the estimating circuit 104. Hence, based on a current selection of the transform unit size and the intra prediction mode, the estimating circuit 104 performs each distortion estimation regardless the coding unit size. Specifically, any specific block with the selected transform unit size is processed based on the selected intra prediction mode to evaluate a corresponding distortion value.

Step 310 may be performed by the setting circuit 106. Hence, after a distortion value of a specific block with the selected transform unit size is obtained under the selected intra prediction mode, the setting circuit 106 uses the distortion value obtained at step 308 to set a plurality of distortion values for different coding unit sizes each being larger than or equal to the selected transform unit size. For example, one specific block is at least a portion (i.e., part or all) of one block configured as the first coding unit size, and is also at least a portion (i.e., part or all) of another one block configured as the second coding unit size. Hence, a distortion value of the same specific block (which has the selected transform unit size) under the first coding unit size for the selected intra prediction mode is directly set by the distortion value obtained at step 308, and a distortion value of the same specific block (which has the selected transform unit size) within another one block configured as different coding unit size for the selected intra prediction mode is directly set by the same distortion value obtained at step 308.

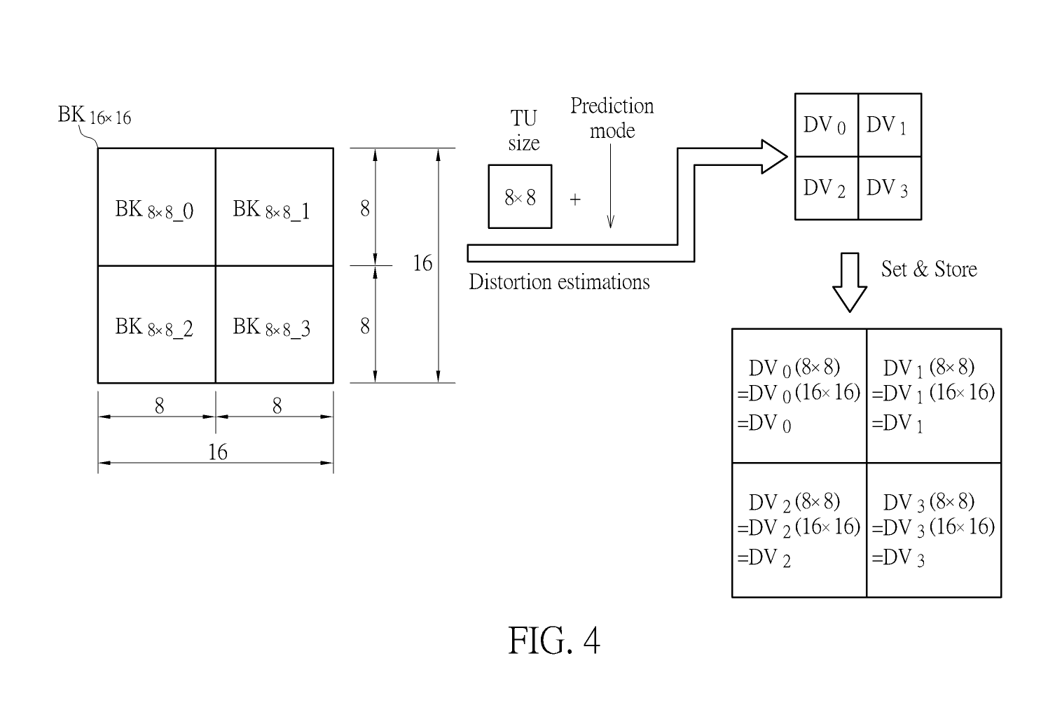

FIG. 4 is a diagram illustrating an example of performing one distortion estimation to set distortion values for different coding unit sizes. In this example, a block of pixels to be encoded may have at least one block BK_{16×16} having the coding unit size of 16×16, or four blocks BK_{8×8}_{_}0, BK_{8×8}_{_}1, BK_{8×8}_{_}2, BK_{8×8}_{_}3, each having the coding unit size of 8×8. The block BK_{16×16} is composed of the blocks BK_{8×8}_{_}0, BK_{8×8}_{_}1, BK_{8×8}_{_}2, BK_{8×8}_{_}3. In a case where the selected transform unit size is 8×8 and the selected intra prediction mode is the vertical prediction, each of the blocks BK_{8×8}_{_}0, BK_{8×8}_{_}1, BK_{8×8}_{_}2, BK_{8×8}_{_}3 has the same selected transform unit size, and is regarded as a specific block waiting to undergo one distortion estimation based on the selected intra prediction mode (e.g., vertical prediction). The estimating circuit 104 therefore generates a distortion value DV₀ for the block BK_{8×8}_{_}0 under the vertical prediction, a distortion value DV₁ for the block BK_{8×8}_{_}1 under the vertical prediction, a distortion value DV₂ for the block BK_{8×8}_{_}2 under the vertical prediction, and a distortion value DV₃ for the block BK_{8×8}_{_}3 under the vertical prediction.

Next, the setting circuit 106 stores the distortion values DV₀−DV₃ for different coding unit sizes. Each of the blocks BK_{8×8}_{_}0, BK_{8×8}_{_}1, BK_{8×8}_{_}2, BK_{8×8}_{_}3 has a coding unit size equal to the selected transform unit size, and is part of the block BK_{16×16} having a coding unit size larger than the selected transform unit size.

In this example, the setting circuit 106 uses the distortion value DV₀ evaluated for a specific block (e.g., block BK_{8×8}_{_}0) based on the selected transform unit size and the selected intra prediction mode to set a distortion value DV₀(8×8) of the same specific block (i.e., block BK_{8×8}_{_}0 under the coding unit size equal to 8×8), and further uses the distortion value DV₀ evaluated for the specific block (e.g., block BK_{8×8}_{_}0) based on the selected transform unit size and the selected intra prediction mode to set to set a distortion value DV₀(16×16) of the same specific block (i.e., block_{8×8}_{_}0 under the coding unit size equal to 16×16) within the block BK_{16×16}.

Similarly, the setting circuit 106 uses the distortion value DV₁ evaluated for a specific block (e.g., block BK_{8×8}_{_}1) based on the selected transform unit size and the selected intra prediction mode to set a distortion value DV₁ (8×8) of the same specific block (i.e., block BK_{8×8}_{_}1 under the coding unit size equal to 8×8), and further uses the distortion value DV₁ evaluated for the specific block (e.g., block BK_{8×8}_{_}1) based on the selected transform unit size and the selected intra prediction mode to set a distortion value DV₁ (16×16) of the same specific block (i.e., block BK_{8×8}_{_}1 under the coding unit size equal to 16×16) within the block BK_{16×16}.

The setting circuit 106 uses the distortion value DV₂ evaluated for a specific block (e.g., block BK_{8×8}_{_}2) based on the selected transform unit size and the selected intra prediction mode to set a distortion value DV₂(8×8) of the same specific block (i.e., block BK_{8×8}_{_}2 under the coding unit size equal to 8×8), and further the distortion value DV₂ evaluated for the specific block (e.g., block BK_{8×8}_{_}2) based on the selected transform unit size and the selected intra prediction mode to set a distortion value DV₂ (16×16) of the same specific block (i.e., block BK_{8×8}_{_}2 under the coding unit size equal to 16×16) within the block BK_{16×16}.

The setting circuit 106 uses the distortion value DV₃ evaluated for a specific block (e.g., block BK_{8×8}_{_}3) based on the selected transform unit size and the selected intra prediction mode to set a distortion value DV₃(8×8) of the same specific block (i.e., block BK_{8×8}_{_}3 under the coding unit size equal to 8×8), and further uses the distortion value DV₃ evaluated for the specific block (e.g., block BK_{8×8}_{_}3) based on the selected transform unit size and the selected intra prediction mode to set a distortion value DV₃ (16×16) of the same specific block (i.e., block BK_{8×8}_{_}3 under the coding unit size equal to 16×16) within the block BK_{16×16}.

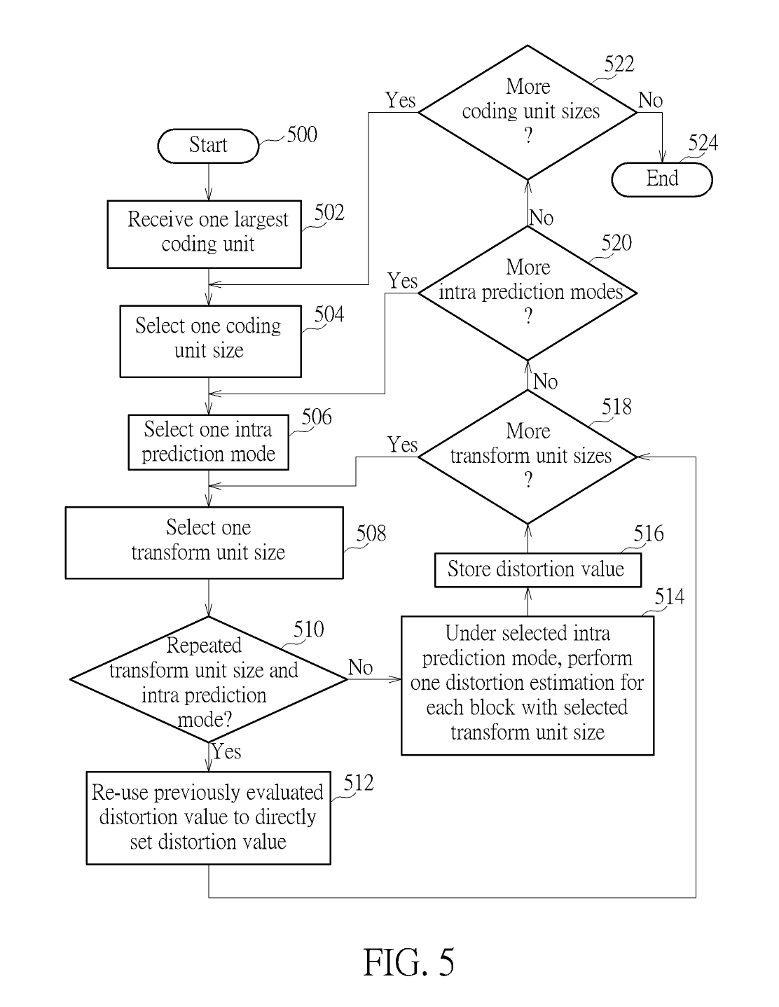

FIG. 5 is a diagram illustrating an intra prediction method using a second distortion estimation flow according to an embodiment of the present invention. Provided that the result is substantially the same, the steps are not required to be executed in the exact order shown in FIG. 5. The intra prediction method may be employed by the intra prediction apparatus 100, and can be briefly summarized as below.

Step 500: Start.

Step 502: Receive one largest coding unit (LCU).

Step 504: Select one coding unit size from unprocessed coding unit size (s).

Step 506: Select one intra prediction mode from unprocessed intra prediction mode(s) associated with the selected coding unit size.

Step 508: Select one transform unit size from unprocessed transform unit size (s) associated with the selected intra prediction mode.

Step 510: Check if a distortion estimation of evaluating a distortion value of each block with the selected transform unit size under the selected intra prediction mode is performed before. If yes, go to step 512; otherwise, go to step 514.

Step 512: Re-use the previously evaluated distortion value to directly set a distortion value of one distortion estimation for each block with the selected transform unit size. Go to step 518.

Step 514: Under the selected intra prediction mode, perform one distortion estimation for each block with the selected transform unit size.

Step 516: Store a distortion value for each block with the selected transform unit size.

Step 518: Check if there is any unprocessed transform unit size associated with the selected intra prediction mode. If yes, go to step 508; otherwise, go to step 520.

Step 520: Check if there is any unprocessed intra prediction mode associated with the selected coding unit size. If yes, go to step 506; otherwise, go to step 522.

Step 522: Check if there is any unprocessed coding unit size. If yes, go to step 504; otherwise, go to step 524.

Step 524: End.

Steps 502, 504, 506, 508, 518, 520, and 522 may be performed by the selecting circuit 102. As can be seen from FIG. 5, the selecting circuit 102 sequentially selects possible combinations of the coding unit size, the transform unit size and the intra prediction mode (steps 504, 506, 508, 518, 520, and 522). For example, the selecting circuit 102 may make a selection of a first coding unit size, a first intra prediction mode and a first transform unit size, and then make another selection of the same first coding unit size, the same first intra prediction mode and a second transform unit size. For another example, the selecting circuit 102 may make a selection of a first coding unit size, a first intra prediction mode and a first transform unit size, and then make another selection of the same first coding unit size, a second intra prediction mode and a second transform unit size. For yet another example, the selecting circuit 102 may make a selection of a first coding unit size, a first intra prediction mode and a first transform unit size, and then make another selection of a second coding unit size, a second intra prediction mode and a second transform unit size. Alternatively, the order of steps 506 and 508 may be swapped, and the order of steps 518 and 520 may be swapped.

In this example, the selection of one coding unit size is made in the selection circuit 102, such that the following estimating circuit 104 may perform distortion estimations for the selected coding unit size. However, it is possible that one or more of the distortion estimations for the selected coding unit size can be skipped due to the fact that the desired distortion values are already available.

Steps 510, 514 and 516 may be performed by the estimating circuit 104. Step 512 may be performed by the setting circuit 106. Though the selecting circuit 102 makes a selection of one selected coding unit size, one selected transform unit size and one selected intra prediction mode, the estimating circuit 104 performs step 105 before actually doing any distortion estimation for the selected coding unit size, the selected transform unit size and the selected intra prediction mode. Specifically, step 510 is used to check if a distortion estimation of evaluating a distortion value of each block with the selected transform unit size under the selected intra prediction mode is performed before. For example, step 510 checks if a specific block (which has the selected transform unit size) under currently selected coding unit size setting (the currently selected coding unit size that may equal to or larger than the selected transform unit size) is going to undergo a distortion estimation under a repeated transform unit size and a repeated intra prediction mode. When a checking result indicates that the distortion estimation of evaluating the distortion value of the specific block under the selected intra prediction mode and the selected transform unit size is performed by the estimating circuit 104 before, the setting circuit 106 re-uses the previously evaluated distortion value of the same specific block under a previously selected coding unit size setting (a previously selected coding unit size different from the currently selected coding unit size) to set the distortion value of the specific block under currently selected coding unit size setting (step 512).

However, when the checking result indicates that the distortion estimation of evaluating the distortion value of the specific block under the selected intra prediction mode and the selected transform unit size is not performed by the estimating circuit 104 yet, the estimating circuit 104 generates and stores a desired distortion value derived from performing a distortion estimation upon the specific block based on the selected intra prediction mode and the selected transform unit size (steps 514 and 516).

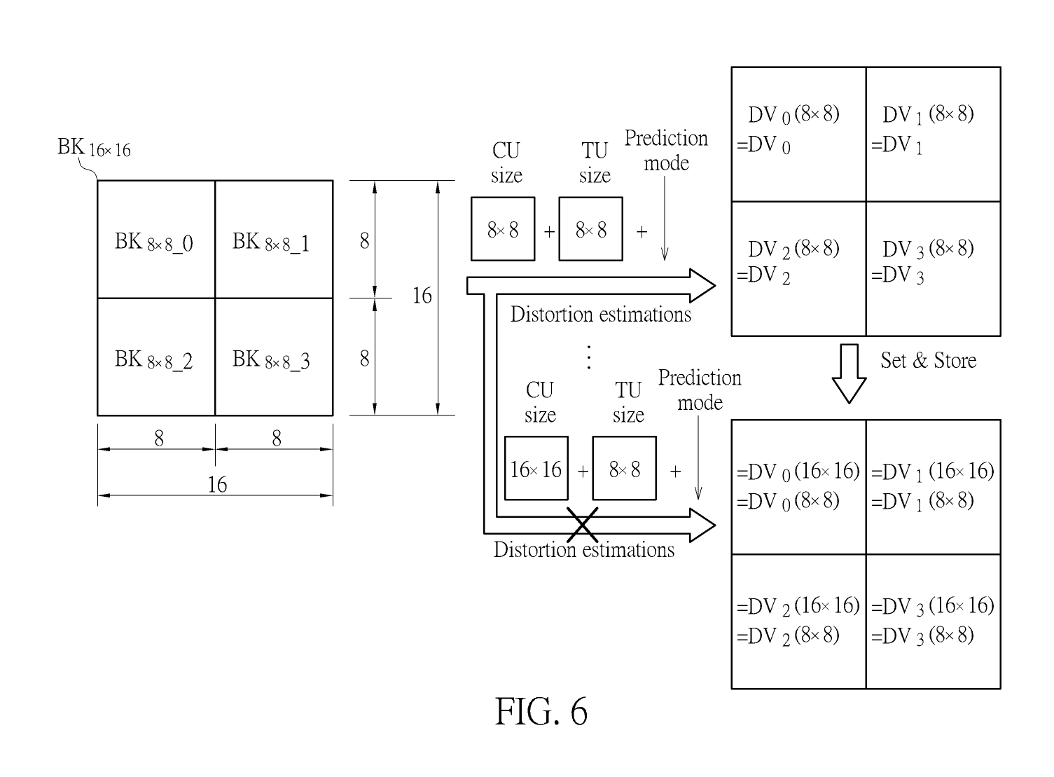

FIG. 6 is a diagram illustrating another example of performing one distortion estimation to set distortion values for different coding unit sizes. In this example, a block of pixels to be encoded may have at least one block BK_{16×16} having the coding unit size of 16×16, or four blocks BK_{8×8}_{_}0, BK_{8×8}_{_}1, BK_{8×8}_{_}2, BK_{8×8}_{_}3, each having the coding unit size of 8×8. Specifically, the block BK_{16×16} is composed of the blocks BK_{8×8}_{_}0, BK_{8×8}_{_}1, BK_{8×8}_{_}2, BK_{8×8}_{_}3. In a case where the selected coding unit size is 8×8, the selected transform unit size is 8×8, and the selected intra prediction mode is the vertical prediction, each of the blocks BK_{8×8}_{_}0, BK_{8×8}_{_}1, BK_{8×8}_{_}2, BK_{8×8}_{_}3 has the same selected transform unit size, and is regarded as a specific block waiting to undergo one distortion estimation based on the selected intra prediction mode (e.g., vertical prediction).

Assuming that the estimating circuit 104 finds that no distortion estimation is performed based on the selected transform unit size (i.e., 8×8) and the selected intra prediction mode (i.e., vertical prediction) before, the estimating circuit 104 generates a distortion value DV₀ for a corresponding specific block (i.e., block BK_{8×8}_{_}0) with the selected transform unit size under the vertical prediction, a distortion value DV₁ for a corresponding specific block (i.e., block BK_{8×8}_{_}1) with the selected transform unit size under the vertical prediction, a distortion value DV₂ for a corresponding specific block (i.e., block BK_{8×8}_{_}2) with the selected transform unit size under the vertical prediction, and a distortion value DV₃ for a corresponding specific block (i.e., block BK_{8×8}_{_}3) with the selected transform unit size under the vertical prediction.

Each of the blocks BK_{8×8}_{_}0, BK_{8×8}_{_}1, BK_{8×8}_{_}2, BK_{8×8}_{_}3 has a coding unit size equal to the selected coding unit size and also equal to the selected transform unit size. In this example, the setting circuit 106 directly uses the distortion value DV₀ as a distortion value DV₀ (8×8) of block BK_{8×8}_{_}0 under the coding unit size of 8×8, directly uses the distortion value DV₁ as a distortion value DV₁ (8×8) of block BK_{8×8}_{_}1 under the coding unit size of 8×8, directly uses the distortion value DV₂ as a distortion value DV₂(8×8) of block BK_{8×8}_{_}2 under the coding unit size of 8×8, and directly uses the distortion value DV₃ as a distortion value DV₃(8×8) of block BK_{8×8}_{_}3 under the coding unit size of 8×8.

As mentioned above, the selecting circuit 102 will keep updating the selection of the coding unit size, the transform unit size and the intra prediction mode, until all of the possible combinations of the coding unit size, the transform unit size and the intra prediction mode have been selected and processed. Suppose that another selection of the coding unit size, the transform unit size and the intra prediction mode made by the selecting circuit 102 includes a selected coding unit size being 16×16, a selected transform unit size being 8×8, and a selected intra prediction mode being the vertical prediction. The estimating circuit 104 finds that distortion estimations are performed based on the selected transform unit size (i.e., 8×8) and the selected intra prediction mode (i.e., vertical prediction) before. Hence, the estimating circuit 104 is prevented from performing the repeated distortion estimations, and the setting circuit 106 is instructed to re-use the distortion values DV₀(8×8)−DV₃ (8×8) previously obtained under the same transform unit size (i.e., 8×8) and intra prediction mode (i.e., vertical prediction) but different coding unit size (i.e., 8×8).

In this example, the setting circuit 106 re-uses the distortion value DV₀(8×8) previously evaluated for a specific block (e.g., block BK_{8×8}_{_}0) based on the same selected transform unit size and selected intra prediction mode to directly set a distortion value DV₀(16×16) of the same specific block (i.e., block BK_{8×8}_{_}0) under the coding unit size of 16×16, re-uses the distortion value Dv₁(8×8) previously evaluated for another specific block (e.g., block BK_{8×8}_{_}1) based on the same selected transform unit size and selected intra prediction mode to directly seta distortion value DV₁(16×16) of the same specific block (e.g., block BK_{8×8}_{_}1) under the coding unit size of 16×16, re-uses the distortion value DV₂(8×8) previously evaluated for another specific block (e.g., block BK_{8×8}_{_}2) based on the same selected transform unit size and selected intra prediction mode to directly set a distortion value DV₂(16×16) of the same specific block (e.g., block BK_{8×8}_{_}2) under the coding unit size of 16×16, and re-uses the distortion value DV₃(8×8) previously evaluated for another specific block (e.g., block BK_{8×8}_{_}3) based on the same selected transform unit size and selected intra prediction mode to directly set a distortion value DV₃(16×16) of the same specific block (e.g., block BK_{8×8}_{_}3) under the coding unit size of 16×16.

To improve the intra prediction efficiency, the present invention also proposes an intra prediction merging method which updates/replaces a current best coding unit size (e.g., a second block configuration supported by a first block) by a coding unit size of a larger block (e.g., a first block configuration supported by the first block) when best intra prediction modes of smaller blocks within the larger block (e.g., second blocks within the first block) are similar or identical. It should be noted that the intra prediction merging method may collaborate with the aforementioned distortion estimation method (which performs a single distortion estimation to set distortion values for different coding unit sizes) to achieve better intra prediction performance. However, this is for illustrative purposes only, and is not meant to be a limitation of the present invention. In practice, a video encoder using any of the proposed distortion estimation method and intra prediction merging method falls within the scope of the present invention. Further details of the proposed intra prediction merging method are described as below.

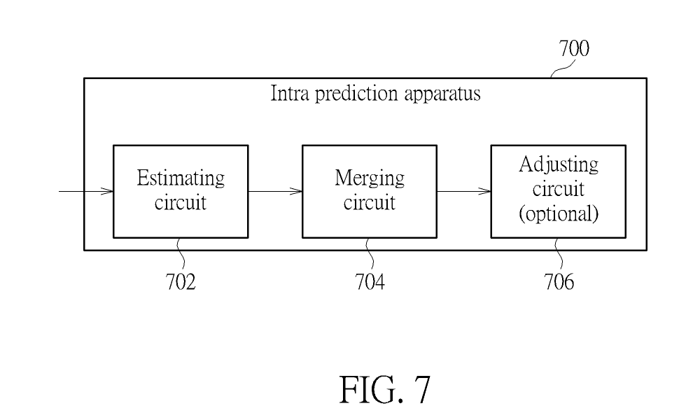

FIG. 7 is a diagram illustrating an intra prediction apparatus according to a second embodiment of the present invention. The intra prediction apparatus 700 may be part of a video encoder supporting one or more video coding standards (e.g., an HEVC standard). In this embodiment, the intra prediction apparatus 700 includes an estimating circuit 702, a merging circuit 704, and an optional adjusting circuit 706. It should be noted that only the circuit components pertinent to the present invention are shown in FIG. 7. In practice, the intra prediction apparatus 700 may include additional circuit components for providing a complete intra prediction function. The estimating circuit 702 is configured to refer to a specific transform unit size to estimate a plurality of best intra prediction modes of a plurality of second blocks. In this case, a first block is defined as having the second blocks included therein, wherein a size of the first block may be equal to a first coding unit size, and a size of each second block may be equal to a second coding unit size smaller than the first coding unit size. Specifically, a block of pixels may be encoded using a larger block (e.g., the first block) or smaller blocks (e.g., the second blocks), and therefore may support a first block configuration (e.g., a size of the first block) and a second block configuration (e.g., a size of each second block). In this embodiment, the second block configuration may be selectively updated by the first block configuration for the first block based on best intra prediction modes found using the second blocks.

The merging circuit 704 is coupled to the estimating circuit, and configured to check similarity of the best intra prediction modes of the second blocks for selectively updating/replacing a current best coding unit size by the first coding unit size, wherein the current best coding unit size is the size of each second block, and the first block with the first coding unit size comprises the second blocks. In one exemplary design, when a majority of the best intra prediction modes of the second blocks are identical to a specific intra prediction mode or the majority of the best intra prediction modes of the second blocks are within a specific range of directions, the merging circuit 704 may be configured to update/replace the current best coding unit size by the first coding unit size. In this embodiment, the merging circuit 704 may derive statistics from best intra prediction modes of the second blocks, and refer to the statistics to determine whether a criterion of updating/replacing the current best coding unit size is met. For example, the criterion is met when the statistics show that the majority of the best intra prediction modes of the second blocks are all of the best intra prediction modes of the second blocks. In other words, when all of the best intra prediction modes of the second blocks are the same (e.g., the same specific intra prediction mode), the merging circuit 704 directly updates the current best coding unit size by the first coding unit size. For another example, the criterion is met when the statistics show that most best intra prediction modes of the second blocks are the same specific intra prediction mode and the number of best intra prediction modes identical to the same specific intra prediction mode exceeds a predetermined threshold. For yet another example, the criterion is met when the statistics show that most best intra prediction modes of the second blocks are within a specific direction range and the number of best intra prediction modes within the specific direction range exceeds a predetermined threshold.

It should be noted that the aforementioned majority decision based criteria are for illustrative purposes only, and are not meant to be limitations of the present invention. In practice, the merging circuit 704 may be configured to employ a different majority decision based criterion for determining whether to update/replace the current best coding unit size. This also falls within the scope of the present invention.

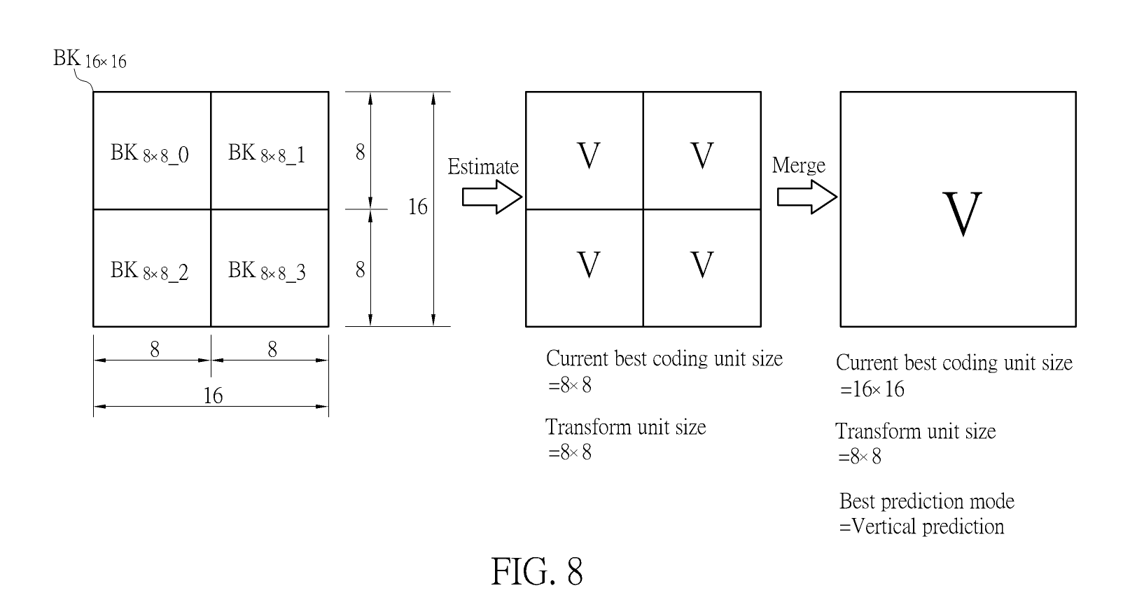

FIG. 8 is a diagram illustrating an example of updating a current best coding unit size by a coding unit size of a larger block when best intra prediction modes of smaller blocks within the larger block are identical. In this example, a block of pixels to be encoded may have at least one block BK_{16×16} having the coding unit size of 16×16, or four blocks BK_{8×8}_{_}0, BK_{8×8}_{_}1, BK_{8×8}_{_}2, BK_{8×8}_{_}3, each having the coding unit size of 8×8. Specifically, the block BK_{16×16} is composed of the blocks BK_{8×8}_{_}0, BK_{8×8}_{_}1, BK_{8×8}_{_}2, BK_{8×8}_{_}3. Suppose that the transform unit size is 8×8, and the current best coding unit size is 8×8. Hence, based on the transform unit size, the estimating circuit 702 estimates a best intra prediction mode for each of the blocks BK_{8×8}_{_}0, BK_{8×8}_{_}1, BK_{8×8}_{_}2, BK_{8×8}_{_}3, each having a coding unit size equal to the current best coding unit size. As shown in FIG. 8, the estimating circuit 702 decides that the best intra prediction mode for each of the blocks BK_{8×8}_{_}0, BK_{8×8}_{_}1, BK_{8×8}_{_}2, BK_{8×8}_{_}3 within the block BK_{16×16} is the vertical prediction (denoted by “V”). Since the best intra prediction modes of the blocks BK_{8×8}_{_}0, BK_{8×8}_{_}1, BK_{8×8}_{_}2, BK_{8×8}_{_}3 within the block BK_{16×16} are all the same, the merging circuit 704 therefore updates the current coding unit size by the coding unit size of the block BK_{16×16}. Hence, the current coding unit size becomes 16×16, and is accompanied by the unchanged transform unit size (i.e., 8×8) and the unchanged best prediction mode (i.e., vertical prediction).

With the help of the proposed intra prediction merging method, a final best coding unit size may be quickly determined by skipping a great amount of computation. In this way, the intra prediction processing time can be shortened.

As mentioned above, the updated best coding unit size is accompanied by a corresponding transform unit size directly inherited from an existing setting before the intra prediction merging operation is performed. In general, a transform unit size assigned to a block is not larger than a coding unit size possessed by the block. That is, it is possible that the transform unit size may be equal to the coding unit size. Before the intra prediction merging operation is performed, the allowed maximum transform unit size is limited by a smaller coding unit size. The inherited transform unit size must be smaller than the current best coding unit size obtained after the intra prediction merging operation updates the current best coding unit size by the first coding unit size. However, it is possible that using the current best coding unit size with a transform unit size larger than the inherited transform unit size but not exceed the current best coding unit size may lead to better coding efficiency. That is, using the current best coding unit size with the inherited transform unit size (which must be smaller than the current best coding unit size) may not ensure the best coding efficiency. To achieve better coding efficiency, the present invention proposes adjusting the transform unit size after the intra prediction merging process. Hence, a final transform unit size is allowed to be different from the transform unit size originally inherited. Extra computation, such as reconstruction of pixels, distortion estimation, and/or encoded bit estimation, may be used to adjust the transform unit size. For example, the final transform unit size may be equal to the current best coding unit size.

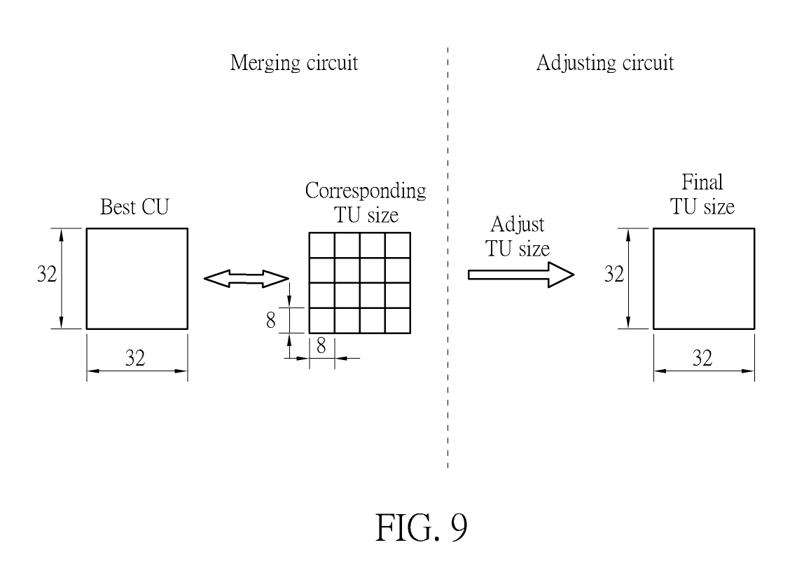

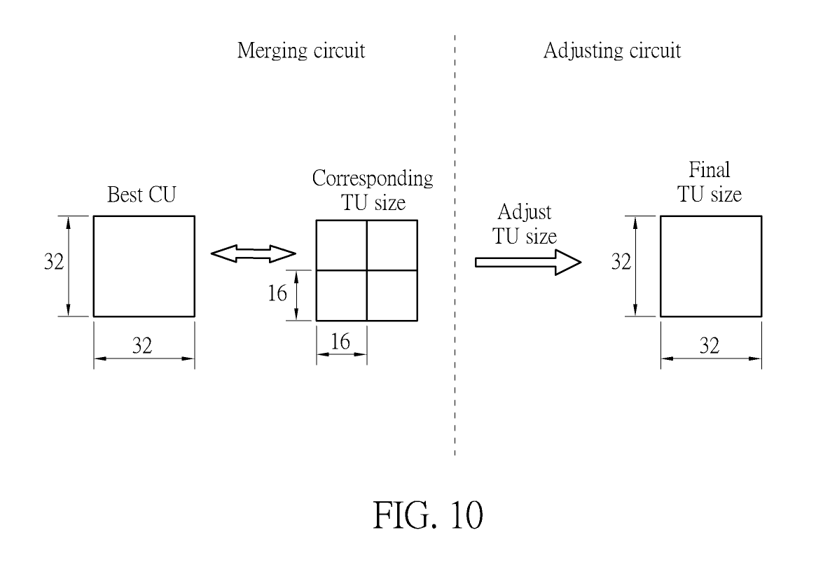

In this example, when a majority of the best intra prediction modes of the second blocks are identical to a specific intra prediction mode, the merging circuit 704 updates the current best coding unit size by the first coding unit size. Specifically, a coding unit with the first coding unit size is selected as a current best coding unit with the specific transform unit size and the specific intra prediction mode when the current best coding unit size is updated by the first coding unit size. The adjusting circuit 706 is coupled to the merging circuit 704, and configured to adjust the specific transform unit size used by the current best coding unit according to the first coding unit size (e.g., the size of the first block that is composed of multiple second blocks) and the specific intra prediction mode. For example, the first coding unit size and the specific intra prediction mode are fixed, and the adjusting circuit 706 performs a distortion estimation process to find a best transform unit size to serve as the final transform unit size. In a case where the current best coding unit size is updated to 32×32 and the inherited transform unit size is 8×8, the adjusting circuit 706 may replace the inherited transform unit size by a final transform unit size equal to 32×32, as shown in FIG. 9. In another case where the current best coding unit size is updated to 32×32 and the inherited transform unit size is 16×16, the adjusting circuit 706 may replace the inherited transform unit size by a final transform unit size being 32×32, as shown in FIG. 10. Since the best coding unit size and the best intra prediction mode are fixed during calibration of the transform unit size, the best transform unit size can be quickly found by the adjusting circuit 706.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An intra prediction method, comprising:
based on a specific transform unit size, estimating a plurality of best intra prediction modes of a plurality of second blocks, wherein a first block is composed of the second blocks, the first block supports a first block configuration and a second block configuration, the first block configuration represents a size of the first block, and the second block configuration represents a size of each second block; and
checking similarity of the best intra prediction modes of the second blocks for selectively replacing the second block configuration by the first block configuration for the first block.

2. The intra prediction method of claim 1, wherein the specific transform unit size is not larger than the size of each second block.

3. The intra prediction method of claim 1, wherein each of the first block and the second blocks is a prediction unit, or each of the first block and the second blocks is a coding unit.

4. The intra prediction method of claim 1, wherein the step of selectively replacing the second block configuration by the first block configuration for the first block comprises:
when a majority of the best intra prediction modes of the second blocks are identical to a specific intra prediction mode or the majority of the best intra prediction modes of the second blocks are within a specific range of directions, replacing the second block configuration by the first block configuration for the first block.

5. The intra prediction method of claim 4, wherein a block configuration of the first block is replaced by the first block configuration with the specific transform unit size and the specific intra prediction mode when a best coding unit size is the second block configuration with the specific transform unit size and the specific intra prediction mode, and the intra prediction method further comprises: based on the size of the first block and the specific intra prediction mode, adjusting the specific transform unit size.

6. An intra prediction apparatus, comprising:
an estimating circuit, configured to refer to a specific transform unit size to estimate a plurality of best intra prediction modes of a plurality of second blocks, wherein a first block is composed of the second blocks, the first block supports a first block configuration and a second block configuration, the first block configuration represents a size of the first block, and the second block configuration represents a size of each second block; and
a merging circuit, configured to check similarity of the best intra prediction modes of the second blocks for selectively replacing the second block configuration by the first block configuration for the first block.

7. The intra prediction apparatus of claim 6, wherein the specific transform unit size is not larger than the size of each second block.

8. The intra prediction apparatus of claim 6, wherein each of the first block and the second blocks is a prediction unit, or each of the first block and the second blocks is a coding unit.

9. The intra prediction apparatus of claim 6, wherein when a majority of the best intra prediction modes of the second blocks are identical to a specific intra prediction mode or the majority of the best intra prediction modes of the second blocks are within a specific range of directions, the merging circuit is configured to replace the second block configuration by the first block configuration for the first block.

10. The intra prediction apparatus of claim 9, wherein a block configuration of the first block is replaced by the first block configuration with the specific transform unit size and the specific intra prediction mode when a best coding unit size is the second block configuration with the specific transform unit size and the specific intra prediction mode; and the intra prediction apparatus further comprises:
an adjusting circuit, configured to adjust the specific transform unit size based on the size of the first block and the specific intra prediction mode.
